(19) United States
(12) Patent Application Publication
(10) Pub. No.: US 2008/0259189 A1
(43) Pub. Date: Oct. 23, 2008

(54) IMAGING-DEVICE DRIVING SYSTEM

(75) Inventors: Hirokazu MAEDA, Saitama (JP); Hiroyuki TANAKA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/869,809

(22) Filed: Oct. 10, 2007

(30) Foreign Application Priority Data
Oct. 12, 2006 (JP) 2006-278519

(51) Int. Cl. H04N 9/64

(52) U.S. Cl. 348/248; 348/E09.037

(57) ABSTRACT

An imaging-device driving system, comprising a clock-signal generator, a smear detector, and a frequency-controller, is provided. The clock-signal generator generates a clock signal. The clock signal is used for driving an imaging device. The smear detector detects whether smear is present in an image signal. The image signal is generated by an imaging device. The frequency-controller raises the frequency of the clock signal when the smear detector detects the presence of the smear in the image signal.

### BACKGROUND OF THE INVENTION

1. Field of the Invention

The present invention relates to an imaging-device driving system that drives an imaging device such that power for driving is conserved even while preventing smear.

2. Description of the Related Art

A charge-transfer-type imaging device, such as a CCD, is used in a digital camera. A characteristic noise, known as smear, may be generated by the charge-transfer-type imaging device. Therefore, smear should be reduced when a charge-transfer-type imaging device is implemented in a digital camera. Various methods of reducing smear, such as an adjustment of the gain in order to increase a signal level of an image signal, its exposure time, or an adjustment of the clock frequency, and so on, have been disclosed. However, such methods of reducing smear may increase power consumption.

### SUMMARY OF THE INVENTION

Therefore, an object of the present invention is to provide an imaging device driving system that mitigates power consumption while reducing smear.

According to the present invention, an imaging-device driving system, comprising a clock-signal generator, a smear detector, and a frequency-controller, is provided. The clock-signal generator generates a clock signal. The clock signal is used for driving an imaging device. The smear detector detects whether smear is present in an image signal. The image signal is generated by the imaging device. The frequency-controller raises the frequency of the clock signal when the smear detector detects the presence of smear in the image signal.

Further, the imaging device is mounted in a photographing apparatus. The power consumption for the photographing apparatus is reduced in a power conservation mode. The frequency-controller lowers the frequency of the clock signal when the smear detector does not detect smear in the image signal in the power conservation mode.

Further, the frequency-controller raises the frequency of the clock signal if smear is detected in the image signal after the frequency-controller lowers the frequency of the clock signal in the power conservation mode.

### BRIEF DESCRIPTION OF THE DRAWINGS

The objects and advantages of the present invention will be better understood from the following description, with reference to the accompanying drawings in which:

FIG. 1 is a block diagram showing the internal structure of a digital camera having an imaging device driving system that is an embodiment of the present invention;

FIG. 2 is a flowchart describing the entire process carried out by the CPU and the AFE while standing by for the release operation;

FIG. 3 is a flowchart describing the smear-reduction process carried out by the CPU and the AFE;

FIG. 4 is a flowchart describing the process in the economic photographing mode carried out by the CPU and the AFE; and

FIG. 5 is a flowchart describing the process for returning to the usual photographing mode carried out by the CPU and the AFE.

### DESCRIPTION OF THE PREFERRED EMBODIMENTS

The present invention is described below with reference to the embodiment shown in the drawings.

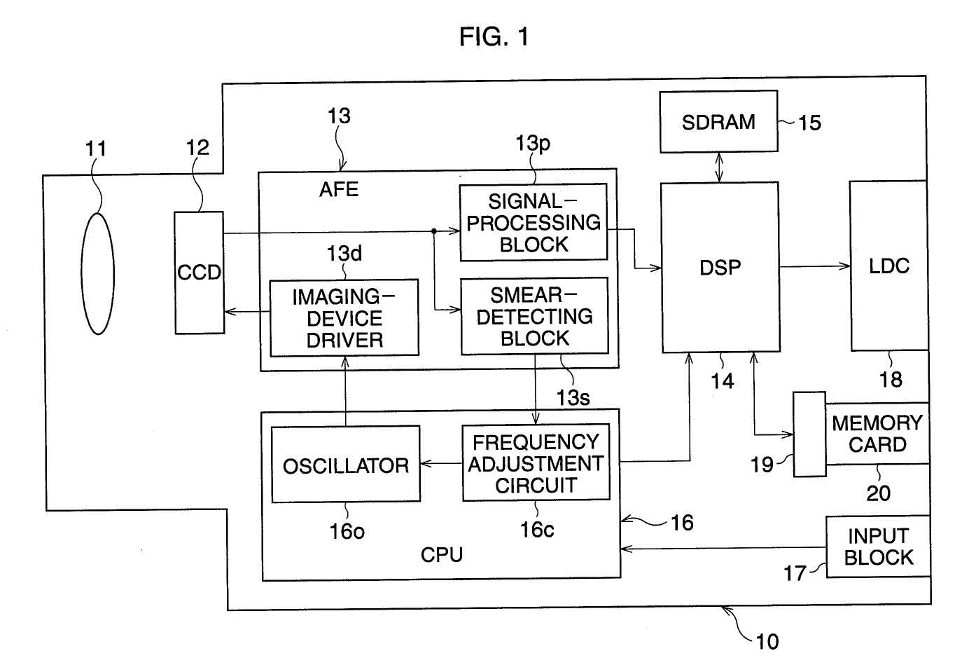

In FIG. 1, a digital camera (photographing apparatus) 10 comprises a photographic optical system 11, an imaging device 12, an analog front end (AFE) 13, a digital signal processor (DSP) 14, a synchronous dynamic random access memory (SDRAM) 15, a CPU 16, an input block 17, a liquid crystal display (LCD) 18, and other components.

The photographic optical system 11 is optically connected to the imaging device 12. An optical image of a subject passes through the photographic optical system 11 and arrives at the light receiving surface of the imaging device 12. The imaging device 12 is, for example, a CCD area sensor. When the imaging device 12 captures the optical image of the subject on its light receiving surface, the imaging device 12 generates an image signal corresponding to the captured optical image.

A shutter (not depicted) is mounted between the photographic optical system 11 and the imaging device 12. An optical image is cast on the light receiving surface by opening the shutter, and an optical image is blocked from the light receiving surface by closing the shutter. A shutter driver (not depicted) drives the shutter so that the shutter can be opened and closed.

The imaging device 12 is electrically connected to the DSP 14 via the AFE 13. The DSP 14 is electrically connected to the CPU 16. A clock signal is sent from the CPU 16 to the AFE 13. The AFE 13 generates an imaging-device driving signal to drive the imaging device, such as a frame signal based on the received clock signal. The imaging-device driving signal is sent to the imaging device 12. The imaging device 12 is driven based on the imaging-device driving signal, which is used by the imaging device 12 to generate an image signal.

The generated image signal is sent to the AFE 13. The AFE 13 carries out correlated double sampling and gain adjustment on the image signal. In addition, the image signal is converted into digital image data. The image data is then sent to the DSP 14.

The image data is sent to the SDRAM 15, which is connected to the DSP 14. The SDRAM 15 comprises first and second buffer areas. The received image data is stored in the first buffer area.

The DSP 14 carries out predetermined data processing on the image data stored in the first buffer area. (0017) The image data, having undergone predetermined data processing, is stored in the second buffer area during standby for a release operation.

The DSP 14 is connected to the LCD 18 and a memory connector 19. The image data, having undergone predetermined data processing, is sent to the LCD 18 and/or the memory card 20 via the memory connector 19 when the release operation is carried out.

While standing by for a release operation in the digital camera 10, the imaging device 12 generates an image signal for a predetermined time interval according to the clock signal. For example, if the frequency of the clock signal is a first frequency, an image signal is generated every 1/15 second. If the frequency of the clock signal is a second frequency that is higher (or greater) than the first frequency, an image signal is generated every 1/30 second. If the frequency of the clock signal is a third frequency that is higher than the second frequency, an image signal is generated every 1/60 second. The image signals generated for the predetermined time interval are stored in the first buffer area, undergo predetermined data processing, and are stored in the second buffer area in that order. The latest image data stored in the second buffer area is sent to the LCD 18 every 1/30 second. By change the displayed image on the LCD 18 every 1/30 second, a real-time moving image is displayed on the LCD 18.

Incidentally, even if an image signal is generated every 1/15 second or 1/60 second, image data is sent to the LCD 18 every 1/30 second.

The DSP 14 is connected to the CPU 16. The CPU 16 commands the DSP14 to carry out predetermined data processing on the received image data and to send the image data to the LCD 18 or the memory card 20.

The CPU 16 is connected to the input block 17, where the user inputs commands to the digital camera 10. The input block 17 comprises a release button (not depicted), a cross-key (not depicted), and other buttons. The CPU 16 orders each component of the digital camera 10 to carry out the necessary operations according to the user's command input to the input block 17.

Next, the control of the frequency of the clock signal is explained in detail with reference to the internal structure of the AFE 13 and the CPU 16.

The AFE 13 comprises a signal-processing block 13p, a smear-detecting block (smear detector) 13s, an imaging device driver 13d, and other components. An image signal generated by the imaging device 12 is input to the signal-processing block 13p and the smear-detecting block 13s. The signal-processing block 13p carries out predetermined signal processing, such as correlated double sampling and A/D conversion on the image signal, as mentioned above.

The smear-detecting block 13s detects smear in a photographed image on the basis of the received image signal. Smear is detected by determining whether the signal level of a pixel signal generated by an optically black pixel whose photodiode is shielded, exceeds a predetermined threshold level. Incidentally, any other known methods to detect smear can be adopted. If smear is detected, a smear-detection signal is sent from the smear-detecting block 13s to the CPU 16.

The smear-detection signal is input to a frequency-adjustment circuit (frequency controller) 16c in the CPU 16. The CPU 16 further comprises an oscillator (clock signal generator) 16o. The oscillator 16o generates the clock signal used to drive the imaging device 12. If the frequency-adjustment circuit 16c receives the smear-detection signal, the frequency-adjustment circuit 16c commands the oscillator 16o to adjust the frequency of the clock signal.

The frequency of the clock signal can be selected from a first, second, and third frequencies. The second frequency is predetermined to be higher than the first frequency, and the third frequency is the highest. The clock signal of the second frequency is generated during usual standby for a release operation.

If the frequency-adjustment circuit 16c receives the smear-detection signal, the frequency-adjustment circuit 16c commands the oscillator 16o to increase the frequency of the clock signal to a higher one. Accordingly, the frequency of the clock signal is changed from the first frequency to the second frequency, or from the second frequency to the third frequency.

The clock signal generated by the oscillator 16o is sent to the imaging device driver 13d. The imaging device driver 13d generates the imaging-device driving signal, such as a frame signal, a vertical transfer pulse, and a horizontal transfer pulse, based on the received clock signal. As described above, the imaging-device driving signal is sent to the imaging device, which generates an image signal based on the received imaging-device driving signal.

Incidentally, the digital camera 10 has a usual photographing mode and an economic photographing mode (power conservation mode). In the usual photographing mode, each component of the digital camera 10 is ordered to work so that a user can use the digital camera comfortably. In the economical operation mode, a power economy operation is carried out. For example, in the economic photographing mode, the luminosity of the backlight of LCD 18 is decreased and the frequency of the clock signal is lowered to the first frequency.

The frequency-adjustment circuit 16c is connected to a timer (not depicted). The timer clocks the time passed since the latest command input, hereinafter referred to as no-command time. When the no-command time exceeds a predetermined period while standing by for a release operation, the operation mode of the digital camera 10 changes to the economic photographing mode from the usual photographing mode. When there is a command input to the input block 17 in the economic photographing mode, the mode is returned to the usual photographing mode.

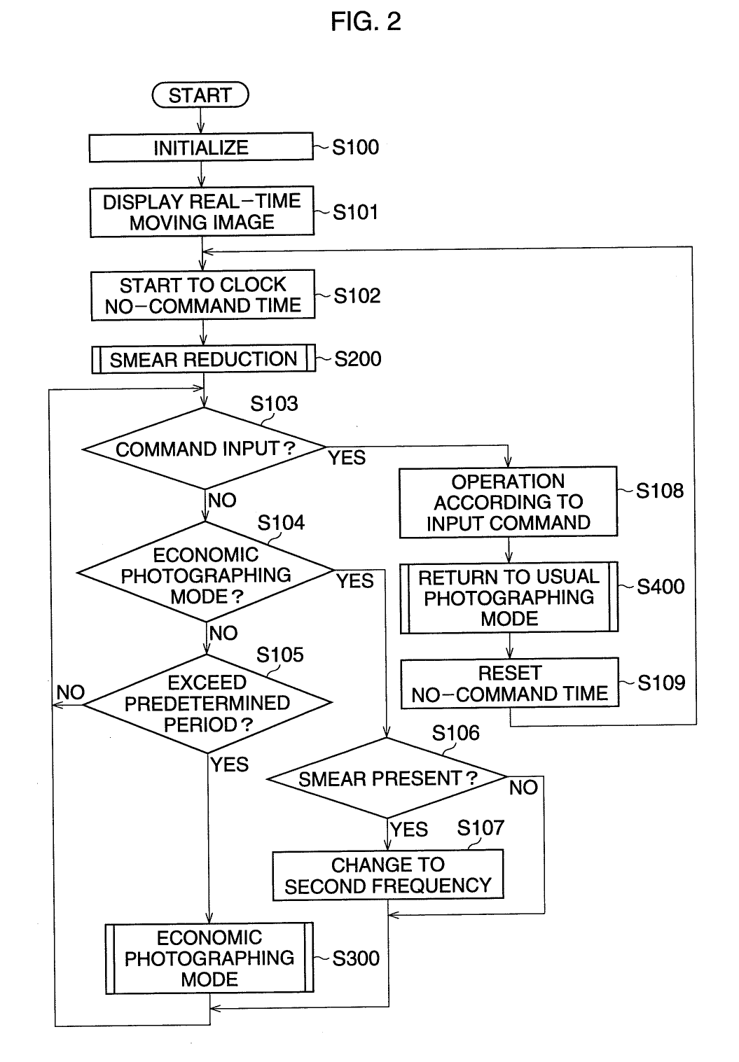

Next, the process that the CPU 16 and the AFE 13 carry out while standing by for a release operation is explained below, using the flowcharts in FIGS. 2-5.

The process starts when the operation mode of the digital camera 10 is changed to a photographing mode including the economic photographing mode and the usual photographing mode. In either photographing mode, the user can take a picture. Incidentally, each process described in FIG. 2 is carried out until the operation mode is changed to another operation mode other than the photographing mode or the power of the digital camera 10 is switched off.

At step S100, each component of the digital camera 10, such as the imaging device 12 and photographic optical system 11, are initialized. At step S101, an optical image is captured for a period dependent on the frequency of the clock signal and the real-time moving image is displayed on the LCD 18. At step S102, the timer starts to clock the no-command time.

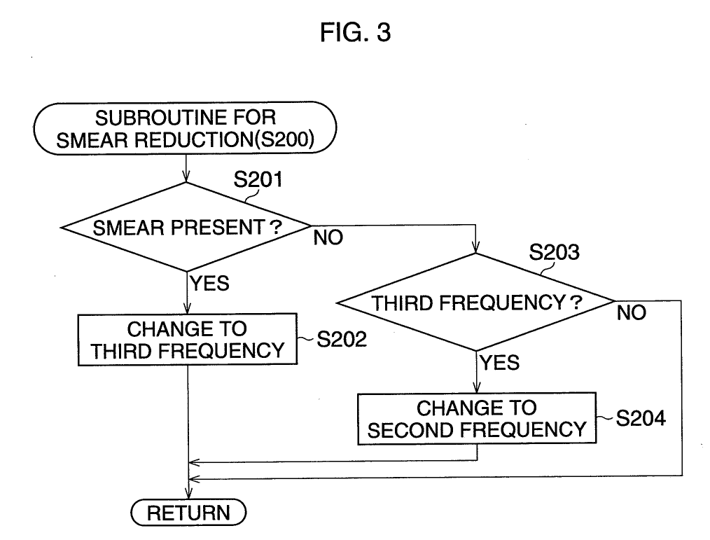

After starting to clock the no-command time, the process proceeds to the subroutine for smear reduction (S200). As shown in FIG. 3, some operations are carried out for reducing smear.

At step S201, it is determined whether smear is present. When smear is present, the process proceeds to step S202, where the frequency of the clock signal is set to the third frequency. On the other hand, when smear is not present at step S201, the process proceeds to step S203.

At step S203, it is determined whether the frequency of the clock signal is set to the third frequency. If the third frequency is in use, the process proceeds to step S204, where the frequency of the clock signal is returned to the second frequency. On the other hand, if the frequency is not the third frequency but the second frequency, the frequency of the clock signal is kept at the second frequency, and then the subroutine for smear reduction ends. Incidentally, when step S202 or S204 ends, so does the subroutine for smear reduction. After termination of the subroutine, the process proceeds to step S103.

At step S103, it is determined whether there is command input to the input block 17 (see FIG. 2). When there is no command input, the process proceeds to step S104, where it is determined whether the operation mode of the digital camera 10 is the economic photographing mode. On the other hand, when there is command input, the process proceeds to step S108, described later.

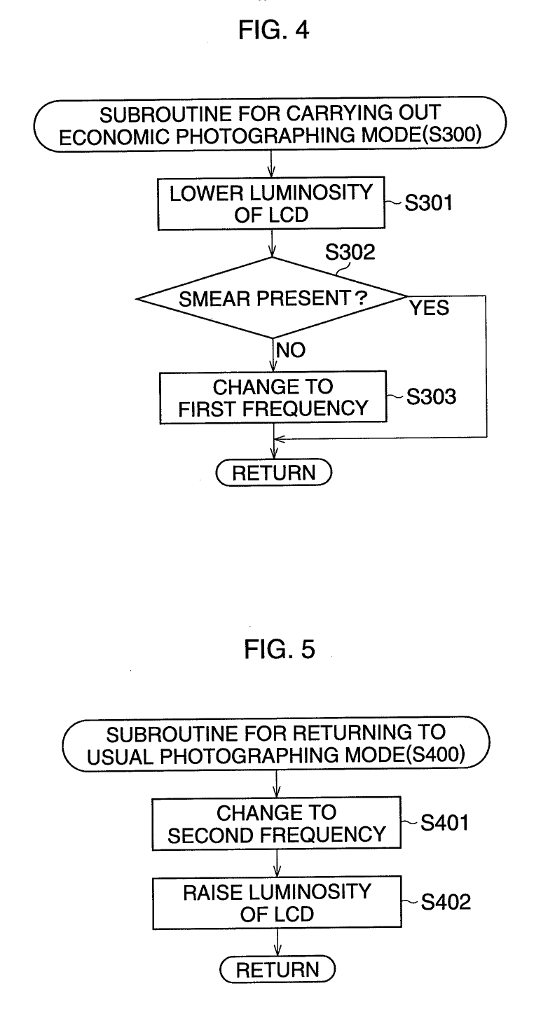

When the operation mode is not the economic photographing mode, the process proceeds to step S105. At step S105, it is determined whether the no-command time exceeds the predetermined period. When the no-command time does not exceed the predetermined period, the process returns to step S103. On the other hand, if the no-command time exceeds the predetermined period, the process proceeds to the subroutine for carrying out the economic photographing mode (S300). FIG. 4 illustrates the subroutine for carrying out the economic photographing mode.

At step S301, the luminosity quantity of the backlight of the LCD 18 is lowered. At step S302, it is determined whether smear is detected. When smear is not detected, the process proceeds to step S303, where the frequency of the clock signal is changed to the first frequency (the lowest frequency). On the other hand, when smear is detected or after step S303 is finished, the subroutine for carrying out the economic photographing mode ends. Then, the process returns to step S103.

When the operation mode is the economic photographing mode at step S104 (see FIG. 2), the process proceeds to step S106, where it is determined whether smear was detected while carrying out the economic photographing mode. When smear is detected, the process proceeds to step S107, where the frequency of the clock signal is returned to the second frequency. On the other hand, when smear is not detected or upon completion of step S107, the process returns to step S103.

As mentioned above, when there is command input to the input block 17, the process proceeds to step S108, where an operation is performed according to the command input to the input block 17, then the process proceeds to the subroutine for returning to the usual photographing mode (S400).

As shown in FIG. 5, at step S401, the frequency of the clock signal is returned to the second frequency. At step S402, the luminosity of the backlight of the LCD 18 is returned to the luminosity of the usual photographing mode. Upon restoring the luminosity, the subroutine for returning to the usual photographing mode ends, and the process proceeds to step S109.

At step S109, the no-command time is reset to zero. After resetting the no-command time, the process returns to step S102, and timing of the no-command time begins.

In the above embodiment, the frequency of the clock signal can be lowered while preventing smear from occurring. By lowering the frequency of the clock signal, power can be conserved by the digital camera 10.

The frequency of the clock signal can be selected from three different frequencies in the above embodiment. However, the frequency selected is not limited to three different frequencies. Furthermore, the frequency can be adjusted successively according to the no-command time.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2006-278519 (filed on Oct. 12, 2006), which is expressly incorporated herein, by reference, in its entirety.

1. An imaging-device driving system comprising:
a clock-signal generator that generates a clock signal, said clock signal being used for driving an imaging device;
a smear detector that detects whether smear is present in an image signal generated by said imaging device; and
a frequency-controller that raises the frequency of said clock signal when said smear detector detects the presence of said smear in said image signal.

2. An imaging-device driving system according to claim 1, wherein said imaging device is mounted in a photographing apparatus, power consumption for said photographing apparatus is reduced in a power conservation mode, and said frequency-controller lowers said frequency of said clock signal when said smear detector does not detect said smear in said image signal in said power conservation mode.

3. An imaging-device driving system according to claim 2, wherein said frequency-controller raises said frequency of said clock signal if said smear is detected in said image signal after said frequency-controller lowers said frequency of said clock signal in said power conservation mode.
